(19) United States
(12) Patent Application Publication
(10) Pub. No.: US 2026/0171339 A1
(43) Pub. Date: Jun. 18, 2026

(54) ELECTRICAL CONTACTOR COMPRISING A SPRING FOR RAPIDLY DRIVING CONTACTS

(71) Applicant: SAFRAN ELECTRICAL & POWER, Blagnac (FR)

(72) Inventors: Kévin ENOUF, Moissy-Cramayel (FR); Guillaume PRIEUR, Moissy-Cramayel (FR); Vaseegan PARAMAGURU, Moissy-Cramayel (FR)

(73) Assignee: SAFRAN ELECTRICAL & POWER, Blagnac (FR)

(21) Appl. No.: 18/993,639

(22) PCT Filed: Aug. 3, 2023
(86) PCT No.: PCT/FR2023/051240

§ 371 Date: Jan. 13, 2025

(30) Foreign Application Priority Data
Aug. 5, 2022 (FR) FR2208128

(51) Int. Cl. H01H 50/56

(52) U.S. Cl. CPC H01H 50/56; H01H 2235/01

(57) ABSTRACT

An electrical contactor including stationary contacts and movable contacts which are movable relative to the stationary contacts between a position of contact with the stationary contacts and a position of separation from the stationary contacts; an actuator for driving the movable contacts to move relative to the stationary contacts towards either the position of contact with the stationary contacts or the position of separation from the stationary contacts; a linkage for driving the movable contacts from the contact position to the separation position, independently of the actuator; the electrical contact is such that the linkage includes a drive spring and a system for disengageably locking the linkage.

### TECHNICAL FIELD

The invention relates to an electrical contactor including an electromagnetic actuator allowing to move movable contacts in the direction of stationary contacts and a system for rapidly driving the movable contacts to rapidly open the contactor.

The invention relates more particularly to an electrical contactor for which the rapid drive system includes a drive spring.

### PRIOR ART

An electrical contactor includes movable contacts, stationary contacts and means for driving the movable contacts.

These drive means include in particular an actuator that is designed to drive the movable contacts to move towards the stationary contacts to close the contactor, or to move away from the stationary contacts to open the contactor.

The contactor can also operate according to a circuit breaker mode, upon the appearance of a short circuit current.

When the electrical contact is broken between the stationary contacts and the movable contacts, an electric arc forms between the stationary contacts and the movable contacts.

In the case of the appearance of the short circuit current, the energy of the electric arc is particularly significant, and thus the electric arc must be cut off as quickly as possible.

Thus, the electrical contactor also includes means for driving the movable contacts allowing to have a high speed of separation of the contacts, in order to have a fast breaking of the electric arc.

A first embodiment of the high-speed drive means includes a pyrotechnical device. An example of such a device is described in the document U.S. Pat. No. 10,388,477. This pyrotechnical device includes a charge which is ignited by an ignition device and which acts on a piston driving the movable contacts.

This solution cannot be subject to tests during the manufacturing of the product.

A second embodiment includes a compression spring, which releases the potential energy that it stores to drive the movable contacts. Such a loaded spring is disposed in the axis of movement of the movable contacts.

According to this solution, to have a sufficient amplitude of movement of the movable contacts as well as a sufficient speed, the dimensions of the spring are significant with respect to the total dimensions of the electrical contactor, in particular for an electrical contactor that is intended to be mounted in an aircraft.

The goal of the invention is to propose an electrical contactor including means for driving the movable contacts at high speed that does not have the disadvantages described above.

### DISCLOSURE OF THE INVENTION

The invention proposes an electrical contactor including stationary contacts and movable contacts that are movable relative to the stationary contacts between a position of contact with the stationary contacts and a position of separation from the stationary contacts,
an actuator for driving the movable contacts to move relative to the stationary contacts towards one or the other of the position of contact with the stationary contacts and the position of separation from the stationary contacts,
a linkage for driving the movable contacts to move from the contact position towards the separation position independently of the actuator,
characterised in that the linkage includes a drive spring and a system for locking the linkage that is disengageable.

Preferably, the spring is an extension spring.

Preferably, the linkage includes a crank mounted pivotably with respect to a stationary axis which is capable of being driven in rotation by the spring and which is capable of driving a connecting rod for driving the movable contacts.

Preferably, a first end of the spring is connected to a stationary axis and a second end of the spring is connected to a movable end of the crank.

Preferably, the locking system includes two articulated small connecting rods which are interposed between a stationary axis and the movable end of the crank, and which are capable of locking the crank in movement, against the action of the spring.

Preferably, the locking system includes a control lever against which a small connecting rod bears when the locking system is in a locking position.

Preferably, the control lever is capable of being rotated by a pusher to drive the locking system towards a position for unlocking the crank.

Preferably, the electrical contactor includes a beam to which the movable contacts are connected, and the beam is connected to an output axis of the actuator and to the linkage via an impact blade.

Preferably, a disengageable link is interposed between the output axis and the beam.

Preferably, the electrical contactor includes support rods supporting the movable contacts and a maintaining spring system interposed between each movable contact and the support rod that is associated with the movable contact.

### BRIEF DESCRIPTION OF THE DRAWINGS

FIG. 1 is a front view diagram of an electrical contactor including a linkage according to the invention.

FIG. 2 is a top view of the electrical contactor shown in FIG. 1.

FIG. 3 is a side view of the electrical contactor shown in FIGS. 1 and 2.

FIG. 4 and

FIG. 5 are views similar to that of FIG. 3, showing two other states of the linkage.

FIG. 6 is a detail in a partial cross-section showing the disengageable link between the output axis and the beam for supporting the movable contacts.

### DETAILED DISCLOSURE OF THE INVENTION

The drawings show an electrical contactor 10 including a pair of stationary contacts 12 and a pair of movable contacts 14. Each stationary contact 12 is connected to a terminal of an electrical circuit.

The movable contacts 14 are electrically connected to each other and they are capable of electrically connecting the stationary contacts 12 to one another to close the electrical circuit.

The movable contacts 14 are mounted movably in translation with respect to the stationary contacts 12 along an axial direction A1 between a disconnection position corresponding to an open configuration of the electrical contactor 10, in which the movable contacts 14 are located at a predefined axial distance with respect to the stationary contacts 12, and a connection position corresponding to a closed configuration of the electrical contactor 10, in which the movable contacts 14 are in electrical contact with the stationary contacts 12 and in which the movable contacts connect the stationary contacts 12 to one another.

The electrical contactor 10 also includes an actuator 16 for driving the movable contacts 14 in translation along the axial direction A1 between their disconnection position and their connection position.

The actuator 16 consists preferably, but not in a limiting way, of an electromagnetic actuator including an output axis 18 extending according to the axial direction A1 and which is movable in translation along the axial direction A1. The output axis 18 carries at its free axial end a beam 20 extending perpendicularly to the output axis 18. The free end of the output axis is connected to a middle of the beam 20. As will be clear below, the link between the free end of the output axis 18 and the beam 20 is disengageable, that is to say that the link can be broken.

The beam 20 includes two lateral ends 22, each of which carries a support rod 24 parallel to the axial direction A1.

The free end of each support rod 24 carries a movable contact 14.

Here, each movable contact 14 consists of a plate linked at its centre to the free end of the support rod 24 that is associated with it.

Preferably, a maintaining spring system 26 is interposed between each movable contact 14 and the free end of the support rod 24 to exert a bearing stress of the movable contact 14 against the stationary contact that is associated with it.

During normal operation, a phase of closing the contactor 10 consists, starting from a disconnection position of the movable contacts 14, of operating the actuator 16 to make the output axis 18 come out.

The output axis 18 drives the beam 20, the support rods 24 and consequently the movable contacts 14.

At an intermediate moment of this closing phase, the movable contacts 14 come in electrical contact with the stationary contacts 12.

Once this intermediate moment has passed, the output axis 18 continues its axial translation, driving the beam 20 and the support rods 24 farther. The maintaining spring system 26 is thus stressed to allow an axial movement of the support rods 24 beyond the position corresponding to the intermediate moment.

After this closing phase, the output axis 18 is in an extreme position outside of the actuator 16, the movable contacts 14 are in contact with the stationary contacts 12 and the maintaining spring system 26 is stressed, allowing to maintain the movable contacts 14 in contact with the stationary contacts 12 regardless of the operating conditions of the contactor 10.

A phase of opening the contactor 10 consists, starting from the extreme closing position for which the movable contacts 14 are in contact with the stationary contacts 12 and the maintaining spring system 26 is stressed, of operating the actuator 16 to cause a retraction of the output axis 18.

The output axis 18 thus carries out an inverse movement allowing first the maintaining spring system 26 to no longer be stressed then a separation of the movable contacts 14 from the stationary contacts 12.

The contactor 10 also has an operating mode called circuit breaker which consists, starting from the extreme closing position, of driving the movable contacts 14 to rapidly separate them from the stationary contacts 12.

This circuit breaker mode is implemented when a short circuit current circulates between the stationary contacts 12 and the movable contacts 14. This short circuit current has the particularity of having a high intensity with respect to the normal operating conditions.

In the presence of this short circuit current, during the separation of the movable contacts 14 from the stationary contacts 12, an electric arc forms. A rapid separation of the contacts 12, 14 allows to rapidly cut off the electric arc thus formed.

To implement this circuit breaker mode, the contactor 10 includes a linkage 30 for driving the movable contacts 14 independently of the actuator 16.

The linkage 30 includes a spring 32 storing a quantity of potential energy and a plurality of connecting rods and cranks that are connected and/or articulated to each other and to the spring 32.

The linkage 30 is further connected to the beam 20 via an impact blade 34 to transmit the potential energy from the spring 32 towards the beam 20 and thus towards the movable contacts 14.

Preferably, the spring 32 is an extension spring, the stiffness of which and the length according to which the spring 32 is elongated are predefined to produce a force that will be transmitted by the rest of the linkage 30 and the impact blade 34 to the beam 20 to drive the movable contacts.

The assembly of connecting rods and cranks is designed to obtain, from the action of the spring 32, a sufficiently high speed of movement of the movable contacts 14.

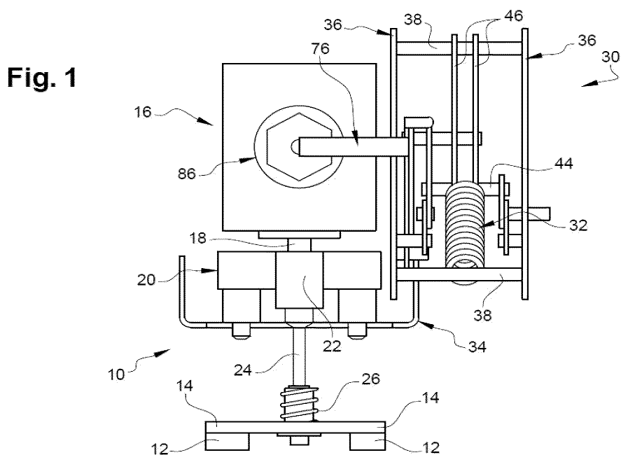

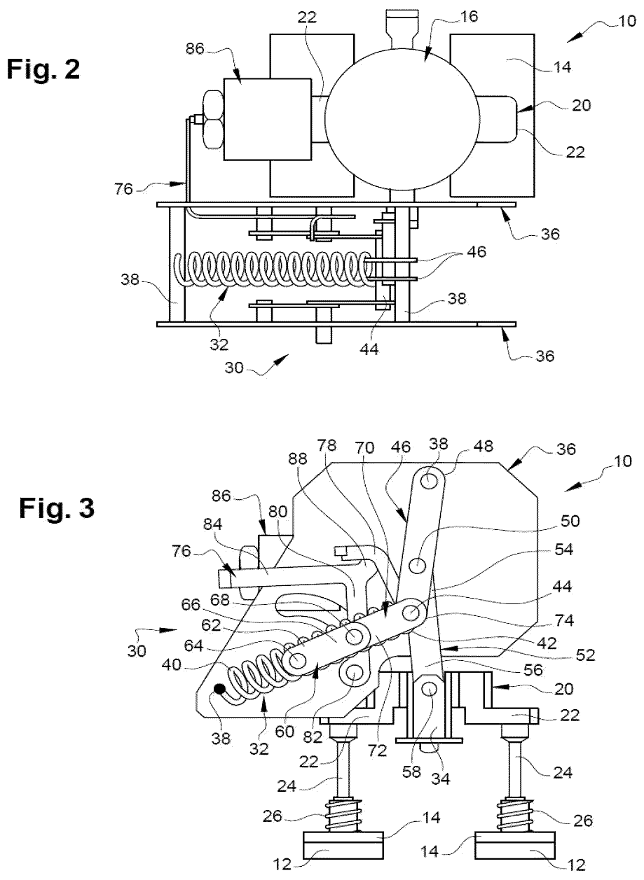

As is visible in FIGS. 1 and 2, the linkage 30 includes two support plates 36 between which the spring 32, the connecting rods and the cranks are disposed. The support plates 36 are stationary with respect to the actuator 16 and are connected to one another by stationary axes 38.

Moreover, preferably, the connecting rods and the cranks are distributed in pairs arranged substantially symmetrically on either side of the spring 32.

According to another alternative embodiment, the linkage 30 is also doubled, that is to say that it includes two sets of connecting rods and cranks as well as two springs 32, which are distributed on either side of the actuator 16. This doubling of the linkage 30 allows to balance the mechanical forces that come into play in the contactor 10.

In the description of the linkage that follows, reference will be made to a single connecting rod or crank of each pair, the description of the other connecting rod or crank will be deduced by similarity.

As is more visible in details in FIG. 3, the spring 32 includes a first end 40 which is connected to a first stationary axis 38 and a second end 42 which is connected to a first movable axis 44.

The linkage 30 includes a first crank 46, a first end 48 of which is articulated with respect to the second stationary axis 38 and a second end of which is articulated to the first movable axis 44. The first crank 46 carries a second movable axis 50 located along the first crank 46 between the second stationary axis 38 and the first movable axis 44.

The linkage 30 includes a first connecting rod 52, a first end 54 of which is connected to the second movable axis 50, and consequently to the first crank 46, and a second end 56 of which is connected to the impact blade 34 via a third movable axis 58.

The stationary and movable axes are arranged in the linkage so that when the linkage 30 is in a loaded position, that is to say before the operation in circuit breaker mode, the first movable axis 44 is offset with respect to a straight line passing through the two stationary axes. Thus, in this loaded position of the linkage, the spring 32 is prestressed in traction. The spring 32 exerts on the first movable axis 44 a stress for driving the first movable axis 44 towards the first stationary axis 38, so that the first movable axis 44 comes into alignment with the two stationary axes 38, which would result in a rotation of the first crank 46 about the second stationary axis 38.

As a consequence of this rotation of the first crank 46, the second movable axis 50 also moves, driving the first connecting rod 52, which drives in turn the impact blade 34 in the direction of the actuator 16.

The stationary axes and the movable axes are also arranged in the linkage 30 to have a reduction of the movement of the first movable axis 44 with respect to the first stationary axis 38 and thus have a significant speed of movement of the third movable axis 58.

The linkage 30 also includes a system for locking the first crank 46 and the first connecting rod 52 in the loaded position. This locking system is disengageable to carry out the circuit breaker mode of the contactor 10.

The locking system includes a first small connecting rod 60, a first end 62 of which is connected to a third stationary axis 64 and a second end 66 of which is connected to a fourth movable axis 68. The locking system includes a second small connecting rod 70, a first end 72 of which is connected to the fourth movable axis 68 and a second end 74 of which is connected to the first movable axis 44.

When the linkage 30 is in the loaded position shown in FIG. 3, the third stationary axis 64 is substantially aligned with the first stationary axis 38 and the first movable axis 44. Thus, the fourth movable axis 68 is offset with respect to the straight line passing through the third stationary axis 64 and the first movable axis 44.

As stated above, the first movable axis 44 is driven to move towards the first stationary axis 38 by the spring 32. Because of the position of the fourth movable axis 68, the action of the spring also tends to move the first movable axis 44 closer to the third stationary axis 64. The locking system is maintained in the position that has just been described by the cooperation of a control lever 76 with a stop bar 78 that is fastened to the second small connecting rod 70.

The control lever 76 has the shape here of an L, it includes a first branch 80 having a vertical orientation in FIG. 3, a free end of which is articulated with respect to a support bar 36 about a fourth stationary axis 82, and it includes a second branch 84 having a horizontal orientation in FIG. 3, a first end of which is connected to the second end of the first branch 80 and the second end of which is free and is connected to a pusher 86.

The control lever 76 further includes a tab 88 located at the linking angle of the two branches 80, 84 and the free end of which cooperates with the free end of the stop bar 78.

The stop bar 78 is connected to the second small connecting rod 70 at the first movable axis 44 and it bears against the tab of the control lever 76 in a direction corresponding to a movement of the first movable axis 44 closer to the first stationary axis and the third stationary axis 64.

Thus, the locking system maintains the first movable axis 44 in its position farthest from the first stationary axis 38 and thus in a loaded position of the linkage 30.

During the triggering of the circuit breaker operating mode of the electrical contactor 10, to unlock the first crank 46 and the first connecting rod 52 in order to drive the impact blade 34, the pusher 86 is activated to rotate the control lever 76 about the fourth stationary axis 82. In this rotation of the control lever 76, the tab 88 bears on the free end of the stop bar 78.

The circuit breaker operating mode of the electrical contactor 10 will be described below on the basis of FIGS. 3 to 5.

In FIG. 3, the electrical contactor 10 is shown in the closing position for which the movable contacts 14 are in electrical contact with the stationary contacts. An electrical current can thus circulate via said contactor. The output axis 18 is in the outside extreme position.

The linkage 30 is in the loaded position, that is to say that the spring 32 is in extension and the locking system is in the position for locking the first movable axis 44.

In the case of the appearance of a short circuit current, the pusher 86 is activated, thus driving the control lever 76 in rotation about the fourth stationary axis 82. The control lever 76 drives in turn the second small connecting rod 70 via the cooperation of the tab 88 on the free end of the stop bar 78.

The second small connecting rod 70 is thus driven to pivot so that the fourth movable axis 68 crosses the straight line that passes through the third stationary axis 64 and the first movable axis 44. When the fourth movable axis 68 goes to the other side of this straight line, the locking system is thus deactivated, thus releasing the first crank 46 and the first connecting rod 52.

Under the action of the spring 32, the first movable axis 44 is driven in the direction of the first stationary axis 38, the crank 46 pivots about the second stationary axis 38, driving the first connecting rod 52 which in turn drives the beam 20 and the movable contacts.

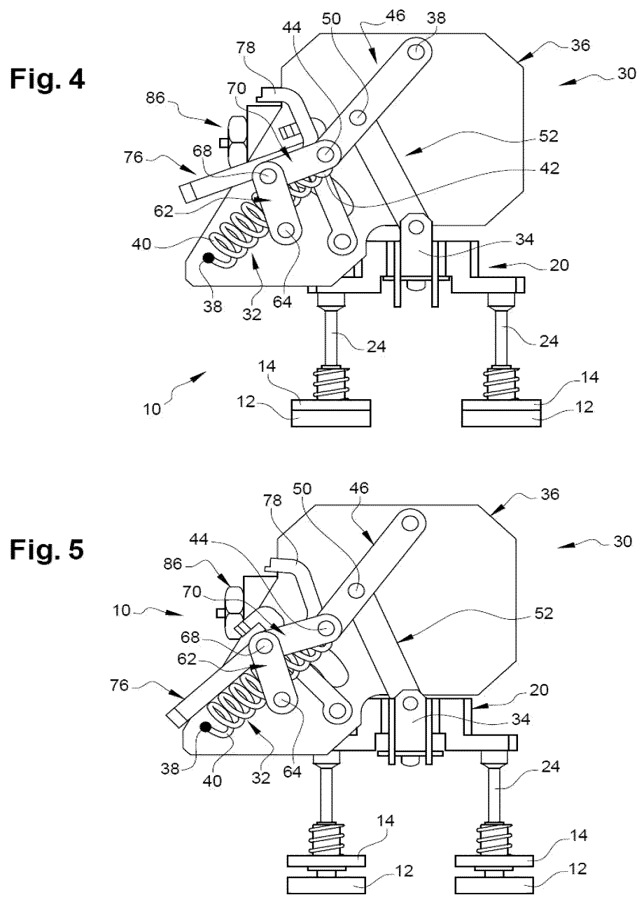

At a first intermediate time shown in FIG. 4, the fourth movable axis 68 has gone to the other side of the straight line passing through the third stationary axis 64 and the first movable axis 44, that is to say that the locking system is deactivated.

The crank 46 has started its pivoting about the second stationary axis 38 driving the beam 20.

At the intermediate moment shown in FIG. 4, the beam 20 has moved by a certain distance corresponding to the movement of the beam 20 and of the support rods 24 with respect to the movable contacts allowed by the maintaining spring systems 26.

Once this intermediate moment has passed, that is to say between the intermediate moment shown in FIG. 4 and the moment shown in FIG. 5, the electrical contact between the movable contacts 14 and the stationary contacts 12 is broken, an electric arc forms between the stationary contacts and the movable contacts.

However, the first crank 46 is still driven to pivot by the spring 32, thus driving the first connecting rod 52 and the beam 20. Its speed of pivoting allows to have a speed of movement of the beam 20, of the support rods 24 and of the movable contacts 14 via the linkage 30 sufficiently high for the electric arc to be rapidly cut off.

After the movement of the beam 20, of the support rods 24 and of the movable contacts 14, as visible in FIG. 5, the movable contacts 14 are at a separation distance sufficiently great with respect to the stationary contacts 12, the electrical contactor 10 is fully open.

During the implementation of the circuit breaker operating mode of the electrical contactor 10 the actuator 16 is in an activated configuration for which the output axis 18 is totally outside.

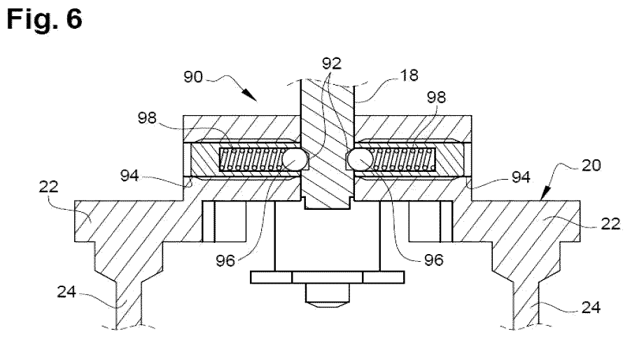

To allow the movement of the beam 20 independently of the position of the output axis 18, a disengageable link 90 shown in FIG. 6 is interposed between the output axis 18 and the beam 20. This disengageable link 90 consists here of a ball and spring link.

The output axis 18 includes a peripheral groove 92 and the beam 20 includes two housings 94 oriented radially with respect to the output axis 18 and which open into a central orifice of the beam 20 through which the output axis 18 passes. A ball 96 and a push spring 98 are disposed in each housing 94.

Each ball 96 is intended to be received partly in the groove 92 of the output axis and the push spring 98 associated with this ball 96 exerts on the ball 96 a stress for maintaining the ball 96 in the groove 92.

The depth of the groove 92 as well as the stiffness of the push spring 98 are defined to maintain the beam 20 immobile with respect to the output axis 18 under normal operating conditions of the electrical contactor 10.

During the implementation of the circuit breaker operating mode of the electrical contactor 10, the stress for driving the beam 20 by the linkage 30 causes the balls 96 to exit the groove 92. Once the balls 96 have exited the groove 92, the balls 96 are in contact with the outer cylindrical surface of the output axis, the resistance to the relative movement of the beam 20 with respect to the output axis 18 is thus negligible.

1. An electrical contactor including stationary contacts and movable contacts that are movable relative to the stationary contacts between a position of contact with the stationary contacts and a position of separation from the stationary contacts
an actuator for driving the movable contacts to move relative to the stationary contacts towards one or the other of the position of contact with the stationary contacts and the position of separation from the stationary contacts
a linkage for driving the movable contacts to move from the contact position towards the separation position independently of the actuator
wherein the linkage includes a drive spring and a system for locking the linkage that is disengageable.

2. The electrical contactor according to claim 1, wherein the spring is an extension spring.

3. The electrical contactor according to claim 1, wherein the linkage includes a crank mounted pivotably with respect to a stationary axis which is capable of being driven in rotation by the spring and which is capable of driving a connecting rod for driving the movable contacts

4. The electrical contactor according to claim 3, wherein a first end of the spring is connected to a stationary axis and a second end of the spring is connected to a movable end of the crank

5. The electrical contactor according to claim 4, wherein the locking system includes two articulated small connecting rods which are interposed between a stationary axis and the movable end of the crank, and which are capable of locking the crank in movement, against the action of the spring

6. The electrical contactor according to claim 5, wherein the locking system includes a control lever against which a small connecting rod bears when the locking system is in a locking position.

7. The electrical contactor according to claim 6, wherein the control lever is capable of being rotated by a pusher to drive the locking system towards a position for unlocking the crank

8. The electrical contactor according to claim 1, which includes a beam to which the movable contacts are connected, wherein the beam is connected to an output axis of the actuator and to the linkage via an impact blade

9. The electrical contactor according to claim 8, wherein a disengageable link is interposed between the output axis and the beam

10. The electrical contactor according to claim 1, wherein the electrical contactor includes support rods supporting the movable contacts and a maintaining spring system interposed between each movable contact and the support rod that is associated with the movable contact
